(19) United States
(12) Patent Application Publication
(10) Pub. No.: US 2009/0231625 A1
(43) Pub. Date: Sep. 17, 2009

(54) SENDING APPARATUS, RECEIVING APPARATUS, CONTROL METHOD OF THESE APPARATUSES, AND STORAGE MEDIUM

(75) Inventors: Akio Suzuki, Tokyo (JP); Nobushige Nomura, Chigasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/405,145

(22) Filed: Mar. 16, 2009

(30) Foreign Application Priority Data
Mar. 17, 2008 (JP) 2008-067732

(51) Int. Cl. G06F 3/12

(52) U.S. Cl. 358/1.15

(57) ABSTRACT

A sending apparatus transmits a call to a receiving apparatus to send image data. If a response from the receiving apparatus to the call indicates that the receiving apparatus is in a non-receivable status, the sending apparatus secures a communication channel for sending the image data to the receiving apparatus until the receiving apparatus sends a notification that the receiving apparatus has shifted to a receivable status. A receiving apparatus notifies a sending apparatus of a non-receivable status, when the receiving apparatus receives a call to send image data from the sending apparatus while it is in the non-receivable status.

### BACKGROUND OF THE INVENTION

1. Field of the Invention

The present invention relates to a sending apparatus which sends image data, a receiving apparatus which receives image data, a control method of these apparatuses, and a storage medium.

2. Description of the Related Art

Conventionally, various methods for sending and receiving image data via a network are discussed as follows. When a sending apparatus sends image data to a receiving apparatus, the sending apparatus first transmits a call for sending the image data to the receiving apparatus. Then, when the call from the sending apparatus is received, the receiving apparatus determines whether it is in a receivable status, and notifies the sending apparatus that the receiving apparatus is in the receivable status or is in a non-receivable status according to a result of the determination. When a notification that the receiving apparatus is in the receivable status is received therefrom, the sending apparatus sends the image data to the receiving apparatus.

Alternatively, when a notification that the receiving apparatus is in the non-receivable status is received therefrom, the sending apparatus cannot send the image data to the receiving apparatus. The receiving apparatus is in the non-receivable status when, for example, it is in the middle of data communication with another apparatus which is different from the sending apparatus that transmitted the call.

When the image data cannot be sent, a user at the sending apparatus side has to make contact by telephone with a user at the receiving apparatus side and transmits the call again after confirming whether the receiving apparatus has shifted to the receivable status, or the sending apparatus needs to automatically repeat retransmission of the call to the receiving apparatus.

To cope with such a situation, Japanese Patent Application Laid-Open No. 2006-067045 discusses a following method. When a sending apparatus transmits a call for sending image data to a receiving apparatus, if the receiving apparatus is in a non-receivable status, the sending apparatus sends a recovery notification message to the receiving apparatus. The recovery notification message requests the receiving apparatus to notify the sending apparatus of recovery, when the receiving apparatus recovered from the non-receivable status to a receivable status. The receiving apparatus that received the recovery notification message will notify the sending apparatus of the recovery when the receiving apparatus recovers from the non-receivable status to the receivable status. Consequently, the sending apparatus can send the image data by retransmitting the call after receiving the notification from the receiving apparatus, so that contact by telephone and repeat of retransmission of the call as described above are not necessary.

However, the above described method of Japanese Patent Application Laid-Open No. 2006-067045 may cause a situation as described below. Even if the receiving apparatus would notify the sending apparatus that the receiving apparatus has shifted to the receivable status, the sending apparatus cannot immediately send the image data in a case where the sending apparatus is in a non-transmittable status at that moment (for example, in the middle of communicating with another apparatus). Further, when some time has elapsed after the sending apparatus becomes unable to send the image data, if the sending apparatus would attempt to send the image data again, the receiving apparatus might have already shifted to the non-receivable status again at that moment. In this case, the sending apparatus cannot send the image data as well. Thus, even if the receiving apparatus would notify the sending apparatus that the receiving apparatus has shifted to the receivable status by using the method of Japanese Patent Application Laid-Open No. 2006-067045, the sending apparatus may not immediately send the image data in some cases.

### SUMMARY OF THE INVENTION

According to an aspect of the present invention, a sending apparatus which sends image data includes a call unit configured to transmit a call to a receiving apparatus to send the image data, and a securing unit configured to secure a communication channel for sending the image data to the receiving apparatus until the receiving apparatus sends a notification that the receiving apparatus has shifted to a receivable status, if a response from the receiving apparatus to the call transmitted by the call unit indicates that the receiving apparatus is in a non-receivable status.

According to another aspect of the present invention, a receiving apparatus which receives image data includes a first notification unit configured to notify a sending apparatus, when the receiving apparatus receives a call from the sending apparatus for sending the image data and is in a non-receivable status, that the receiving apparatus is in the non-receivable status, a second notification unit configured to notify the sending apparatus that the receiving apparatus has shifted to a receivable status when the receiving apparatus has shifted to the receivable status after the first notification unit sent a notification, and a securing unit configured to secure, when the receiving apparatus has shifted to the receivable status, a communication channel for receiving the image data from the sending apparatus until the receiving apparatus again receives the call for sending the image data from the sending apparatus that received a notification from the second notification unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a multifunctional peripheral (MFP) according to an exemplary embodiment of the present invention.

FIG. 2 is an overall view of a communication system including a first MFP and a second MFP according to an exemplary embodiment of the present invention.

FIG. 3 illustrates a sending sequence of image data from a first MFP to a second MFP according to an exemplary embodiment of the present invention.

FIG. 4 is a flowchart illustrating operation steps of a first MFP according to an exemplary embodiment of the present invention.

FIG. 5 is a flowchart illustrating operation steps of a first MFP according to an exemplary embodiment of the present invention.

FIG. 6 illustrates an operation screen displayed on an operation panel unit according to an exemplary embodiment of the present invention.

FIG. 7 illustrates a sending sequence of image data from a first MFP to a second MFP according to an exemplary embodiment of the present invention.

FIG. 8 is a flowchart illustrating operation steps of a second MFP according to an exemplary embodiment of the present invention.

FIG. 9 is a flowchart illustrating operation steps of a second MFP according to an exemplary embodiment of the present invention.

FIG. 10 is a flowchart illustrating operation steps of a first MFP according to an exemplary embodiment of the present invention.

FIG. 11 illustrates an operation screen displayed on an operation panel unit according to an exemplary embodiment of the present invention.

FIG. 12 illustrates an address book according to an exemplary embodiment of the present invention.

FIG. 13 is a flowchart illustrating operation steps of a second MFP according to an exemplary embodiment of the present invention.

### DETAILED DESCRIPTION OF THE EMBODIMENTS

Various exemplary embodiments, features, and aspects of the invention will be described in detail below with reference to the drawings.

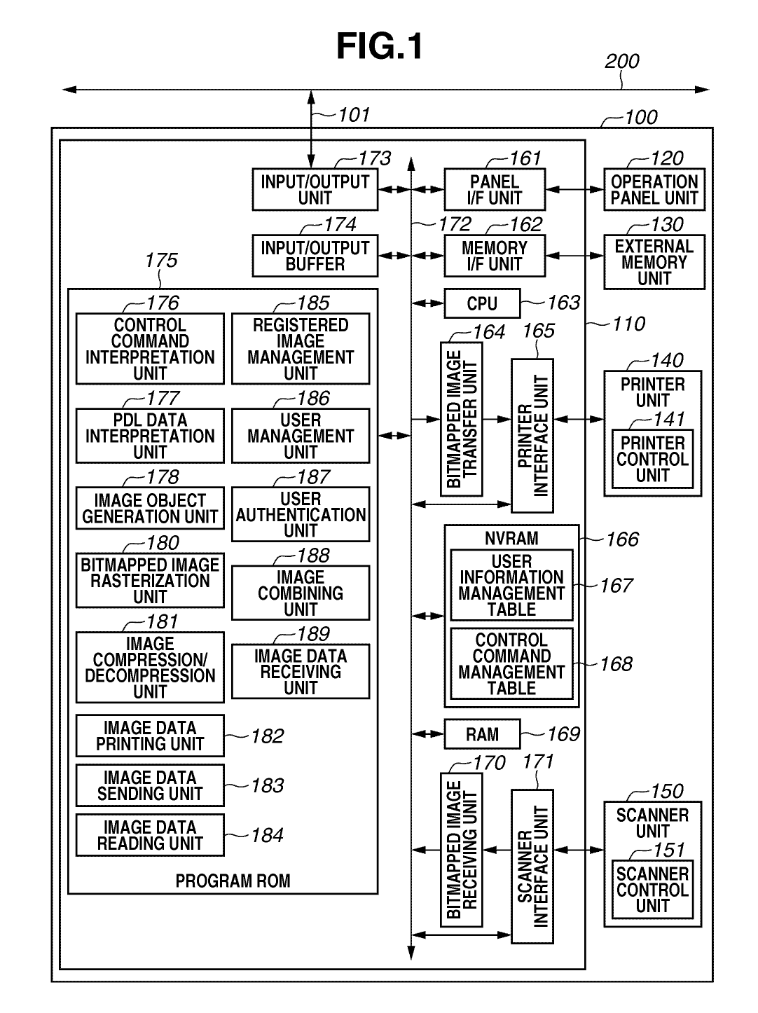

FIG. 1 is a block diagram illustrating a configuration of a multi-functional peripheral (MFP) 100 that functions as a sending apparatus or a receiving apparatus according to a first exemplary embodiment of the present invention. The MFP 100 includes a control unit 110 which controls operation of the entire apparatus, an operation panel unit 120, and an external memory unit 130, a printer unit 140 which prints an image onto a recording paper, and a scanner unit 150 which reads out an image on a document and input the image as image data.

An input/output unit 173 is connected to a local area network (LAN) 200 via a communication line 101, and controls data communication with host computers and other MFPs on the LAN 200. An input/output buffer 174 temporarily stores a page description language (PDL) data and various control commands that are input via the LAN 200, or image data and various control commands that are sent from the MFP 100.

A central processing unit (CPU) 163 controls operation of the entire control unit 110 by executing various programs stored in a program read-only memory (ROM) 175. A random access memory (RAM) 169 is used as a work memory when calculation necessary for analysis of various control commands and processing of image data is performed. A non-volatile random access memory (NVRAM) 166 stores data that needs to be retained, even when the power of the MFP 100 is tuned off.

A control command interpretation unit 176 interprets a print control command received from the host computers on the LAN 200 with reference to information managed by a control command management table 168. A PDL data interpretation unit 177 interprets PDL data received from the host computers.

An image object generation unit 178 generates various image objects. A bitmapped image rasterization unit 180 rasterizes the PDL data that the PDL data interpretation unit 177 has interpreted and the image object that the image object generation unit 178 has generated and generates bitmapped images.

An image compression/decompression unit 181 compresses and decompresses the bitmapped images that the bitmapped image rasterization unit 180 has generated. An image data printing unit 182 controls printing of the image data by a printer unit 140. An image data sending unit 183 controls sending of the image data via the LAN 200. An image data reading unit 184 controls reading of the images and generation of the image data by a scanner unit 150.

A registered image management unit 185 registers and manages the bitmapped images generated by the bitmapped image rasterization unit 180 and images in a fixed format which are used in a form overlay function. A user management unit 186 manages user names, passwords and other information about users who are permitted to use the MFP 100 in a user information management table 167.

A user authentication unit 187 performs a user authentication based on information that is input by a user via the operation panel unit 120, and the information managed by the user management unit 186. An image combining unit 188 combines images to be output from the printer unit 140. An image data receiving unit 189 controls receipt of the image data via the LAN 200.

A bitmapped image transfer unit 164 transfers the bitmapped images generated by the bitmapped image rasterization unit 180 to the printer unit 140 via a printer interface unit 165. A printer control unit 141 provided in the printer unit 140 controls a printing operation in the printer unit 140.

A bitmapped image receiving unit 170 receives the bitmapped images that are generated by the scanner unit 150 based on images on a document via a scanner interface unit 171. A scanner control unit 151 provided in the scanner unit 150 controls scanning (reading the document) operation in the scanner unit 150.

Information to be output from the operation panel unit 120 is transferred via a panel I/F unit 161 to the operation panel unit 120. Also, information that the user inputs via the operation panel unit 120 is input via the panel I/F unit 161, and notified to the CPU 163. Various pieces of information about the image data and the MFP 100 are transferred via a memory I/F unit 162 to the external memory unit 130, and stored within an external memory 130. Each of the above described function units in the control unit 110 are interconnected via a system bus 172.

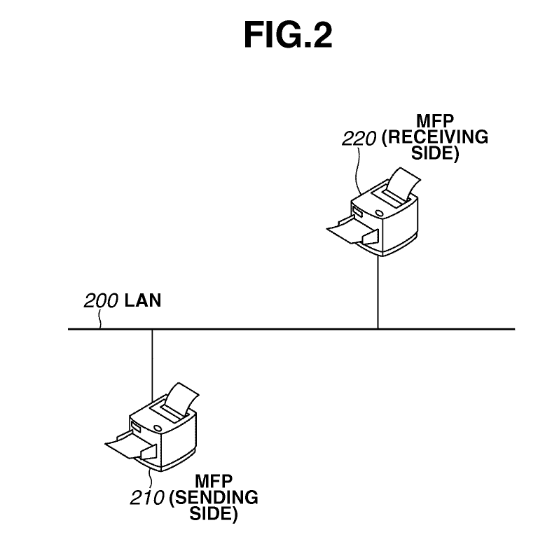

FIG. 2 is an overall view of a communication system including the MFPs 210 and 220 which have similar configuration to that of the above described MFP 100. The MFP 210 and the MFP 220 are communicably connected with each other via the LAN 200. Here, a case where the MFP 210 functions as a sending apparatus and sends the image data to the MFP 220, as well as the MFP 220 functions as a receiving apparatus and receives the image data from the MFP 210 is described. Each MFP performs call control for data communication based on a session initiation protocol (SIP), and sending and receiving the image data by executing facsimile communication according to requirements of Telecommunication Standardization Sector of International Telecommunication Union (ITU-T) Recommendations T.38. The SIP is a standardized communication protocol which is used in the call control for communication of images, audio, and video using an Internet Protocol (IP).

In the first exemplary embodiment, a case is described where the MFP 210 transmits a call to the MFP 220 for sending image data, and a response from the MFP 220 to the call indicates that the MFP 220 is in a non-receivable status. In this case, the MFP 210 requests the MFP 220 to notify the MFP 210 when the MFP 220 has shifted to a receivable status. Further, the MFP 210 secures a communication channel for sending the image data to the MFP 220 until a notification from the MFP 220 is received.

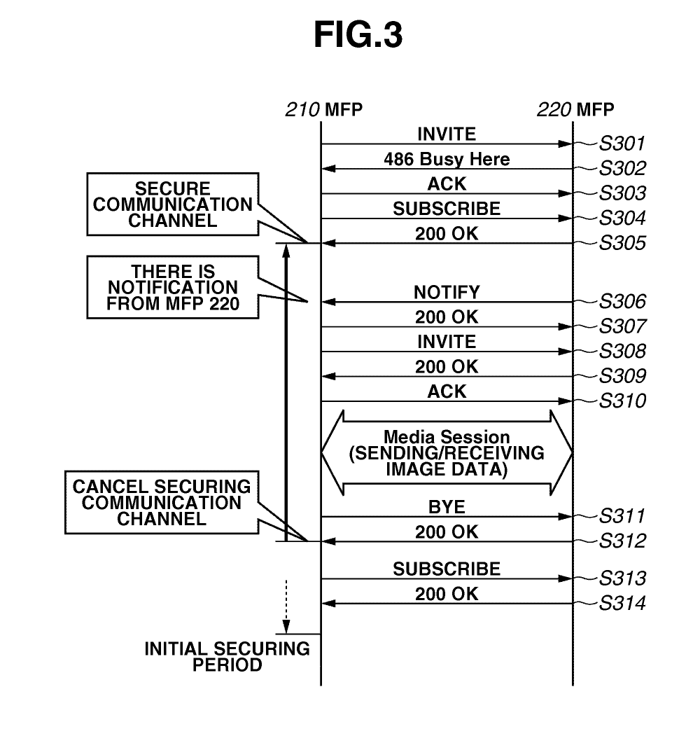

FIG. 3 illustrates a sending sequence of the image data from the MFP 210 to the MFP 220 in the first exemplary embodiment. FIG. 3 illustrates an example where the MFP 210 transmits a call to the MFP 220 for sending the image data, but the MFP 220 is in the non-receivable status, therefore the MFP 210 requests the MFP 220 to notify the MFP 210 that the MFP 220 has shifted to the receivable status, and secures the communication channel.

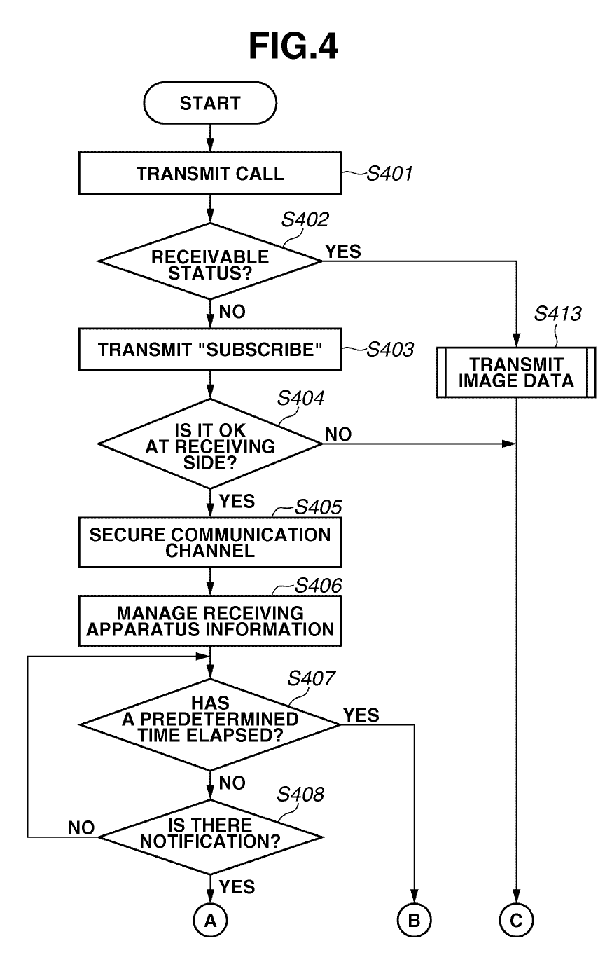

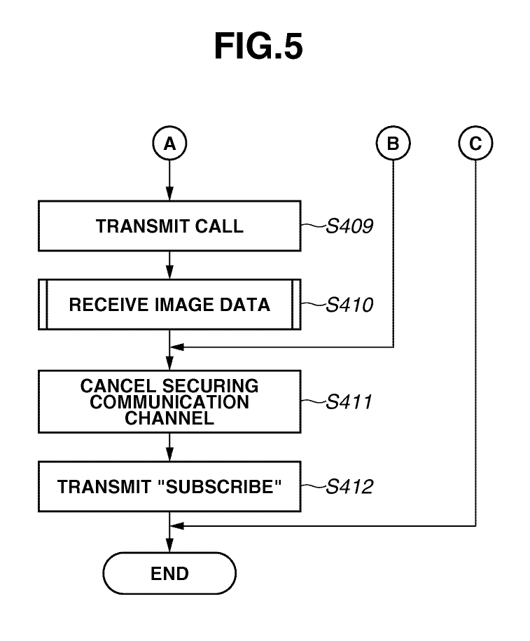

FIGS. 4 and 5 are flowcharts illustrating a series of operations in the MFP 210, when the image data is sent from the MFP 210 to the MFP 220. The CPU 163 of the MFP 210 (MFP 100) controls the series of operations illustrated in these flowcharts based on respective programs stored in the program ROM 175.

First, in step S401, the MFP 210 transmits a call to the MFP 220. More specifically, the MFP 210 sends “INVITE” of SIP message to the MFP 220, as illustrated in step S301 of FIG. 3.

Next, in step S402, the MFP 210 determines whether the MFP 220 is in the receivable status. If the MFP 220 is determined as in the receivable status (YES in step S402), the process proceeds to step S413. If the MFP 220 is determined as in the non-receivable status (NO in step S402), the process proceeds to step S403. Determination in step S402 is performed according to a response from the MFP 220 to the call from the MFP 210. That is, when “486 Busy Here” of the SIP message is sent from the MFP 220, as illustrated in step S302 of FIG. 3, then the MFP 210 determines that the MFP 220 is currently in the non-receivable status. On the other hand, when “200 OK” of the SIP message is sent from the MFP 220, the MFP 210 determines that the MFP 220 is currently in the receivable status. When “486 Busy Here” is sent from the MFP 220, the MFP 210 sends “ACK” of the SIP message to the MFP 220, as illustrated in step S303 of FIG. 3.

Further, in step S403, the MFP 210 transmits “SUBSCRIBE” of the SIP message to the MFP 220 as illustrated in step S304 in FIG. 3. By sending the “SUBSCRIBE”, the MFP 210 can request the MFP 220 to notify the MFP 210 when the MFP 220 has shifted to the receivable status. In an expires field of “SUBSCRIBE”, information indicating a time-out period set by the user using a method as described below is stored. If the MFP 220 that received “SUBSCRIBE” has shifted to the receivable status during a period since the MFP 220 received “SUBSCRIBE” until the time-out period which is indicated by the information stored in the expiration field has elapsed, the MFP 220 notifies the MFP 210 to that effect.

In step S404, the MFP 210 determines whether notification request made by sending “SUBSCRIBE” is accepted by the MFP 220 on a receiving side. More specifically, when “200 OK” is sent from the MFP 220, as illustrated in step S305 in FIG. 3, the MFP 210 determines that the notification request is accepted. On the other hand, if “200 OK” is not sent, or any SIP message other than “200 OK” is sent, the MFP 210 determines that the notification request is not accepted.

When the notification request is accepted by the receiving apparatus (YES in step S404) as a result of determination in step S404, the process proceeds to step S405. If the notification request is not accepted (NO in step S404), the process terminates without any operation. In step S405, the MFP 210 secures the communication channel for sending the image data from the MFP 210 to the MFP 220 when the MFP 220 has shifted to the receivable status. This is because, even though the MFP 210 requests the MFP 220 to notify that the MFP 220 has shifted to the receivable status to send the image data to the MFP 220, the MFP 210 can not send the image data if the MFP 210 is in a non-transmittable status, when the MFP 220 has shifted to the receivable status.

In the first exemplary embodiment, to avoid the above described situation, the MFP 210 sends the notification request to the MFP 220, and secures the communication channel for sending the image data to the MFP 220 on the basis that the notification request is accepted. In other words, the MFP 210 prohibits use of the communication channel for sending the image data to the MFP 220 for data communication with apparatuses other than the MFP 220, and becomes ready for immediately sending the image data to the MFP 220 when the MFP 210 is notified that the MFP 220 has shifted to the receivable status.

Here, an example of securing the communication channel on the basis that the notification request from the MFP 210 is accepted by the MFP 220 (namely, on the basis that the MFP 210 is received “200 OK” in step S305) is described, but other embodiments are available. For example, the MFP 210 may secure the communication channel based on that the MFP 210 sends “SUBSCRIBE” in step S304.

Further, the present exemplary embodiment describes an example of securing the communication channel after sending the notification request to the MFP 220 when it is determined that the MFP 220 is in the non-receivable status, but other aspects are available. For example, if the MFP 220 has a function to notify the sending apparatus that the MFP 220 has shifted to the receivable status when a call from the sending apparatus is transmitted, even if the sending apparatus does not send the notification request, the MFP 210 does not need to send the notification request. In this case, the MFP 210 may secure the communication channel on the basis that the MFP 210 determines that the MFP 220 is in the non-receivable status.

Further, if the MFP 210 has a plurality of communication channels and can respectively execute data communication with a plurality of MFPs in parallel, the MFP 210 has only to secure at least one communication channel among the plurality of communication channels. In this case, other communication channels except for the secured communication channel are permitted to be used for communication with apparatuses other than the MFP 220.

Next, in step S406, the MFP 210 stores and manages information for identifying a destination (i.e., MFP 220) to which “SUBSCRIBE” is sent in the external memory 130. Here, any information can be used for identifying the MFP 220 as long as the information can uniquely identify the MFP 220, such as tag information of From Header of the SIP message and Call_ID.

Then, in step S407, the MFP 210 determines whether a predetermined time has elapsed since the MFP 210 secured the communication channel for sending the image data to the MFP 220. The predetermined time is set in advance by the user using a method as described below. When the predetermined time has elapsed as a result of determination in step S407 (YES in step S407), the process proceeds to step S411, and if not elapsed (NO in step S407), the process proceeds to step S408.

In step S408, the MFP 210 determines whether there is the notification from the MFP 220 that the MFP 220 has shifted to the receivable status. More specifically, when “NOTIFY” of the SIP message is sent from the MFP 220, as illustrated in step S306 in FIG. 3, the MFP 210 determines that there is the notification that the MFP 220 has shifted to the receivable status. If there is the notification from the MFP 220 (YES in step S408), the MFP 210 sends “200 OK” in step S307, then the process proceeds to step S409. If there is no notification from the MFP 220 (NO in step S408), the process returns to step S407.

When making a determination in step S408, the MFP 210 determines whether an MFP that has sent “NOTIFY” is the MFP (the MFP 220) that is indicated by the information managed in step S406. As a result of the determination, if the MFP that has sent “NOTIFY” is the MFP (the MFP 220) that is indicated by the information managed in step S406, the MFP 210 determines that there is the notification from the MFP 220. On the other hand, if the MFP that has sent “NOTIFY is not the MFP (the MFP 220) that is indicated by the information managed in step S406, the MFP 210 determines that there is no notification from the MFP 220, and the process returns to step S407.

In step S409, the MFP 210 again transmits the call for sending the image data to the MFP 220 similar to step S401. That is, as illustrated in FIG. 3, the MFP 210 sends “INVITE” to the MFP 220, in step S308. Then, if “200 OK” is sent from the MFP 220 in step S309, the MFP 210 sends “ACK” to the MFP 220 in step S310. After that, in step S410, the process moves to a media session and the MFP 210 sends the image data to the MFP 220.

In step S402, if the MFP 220 is determined as in the receivable status (YES in step S402), the MFP 210 similarly sends the image data. In other words, the MFP 210 sends “ACK” to the MFP 220, then in step S413, the process moves to the media session, and the MFP 210 sends the image data to the MFP 220. In FIG. 3, upon completion of sending the image data, the MFP 210 sends “BYE” of the SIP message to the MFP 220 in step S311, and further receives “200 OK” sent from the MFP 220 in step S312.

In step S411, the MFP 210 releases the secured communication channel for sending the image data to the MFP 220. In other wards, the MFP 210 opens the communication channel secured in step S405, so that the communication channel can be used for data communication with other MFPs except for the MFP 220. Further, in step S412 and in step S313, the MFP 210 transmits again “SUBSCRIBE” to the MFP 220 to cancel the notification request. In the expiration field of “SUBSCRIBE” which is sent here, information indicating that the time-out period is zero is stored. By sending the “SUBSCRIBE”, the MFP 210 can cancel the notification request to the MFP 220 which was made by sending “SUBSCRIBE” in step S403 and in step S304. If “200 OK” is sent from the MFP 220 in step S314 as a response to “SUBSCRIBE” sent by the MFP 210, a series of operations terminates. As described above, the MFP 210 can be ready for reliably sending the image data when the MFP 220 has shifted to the receivable status.

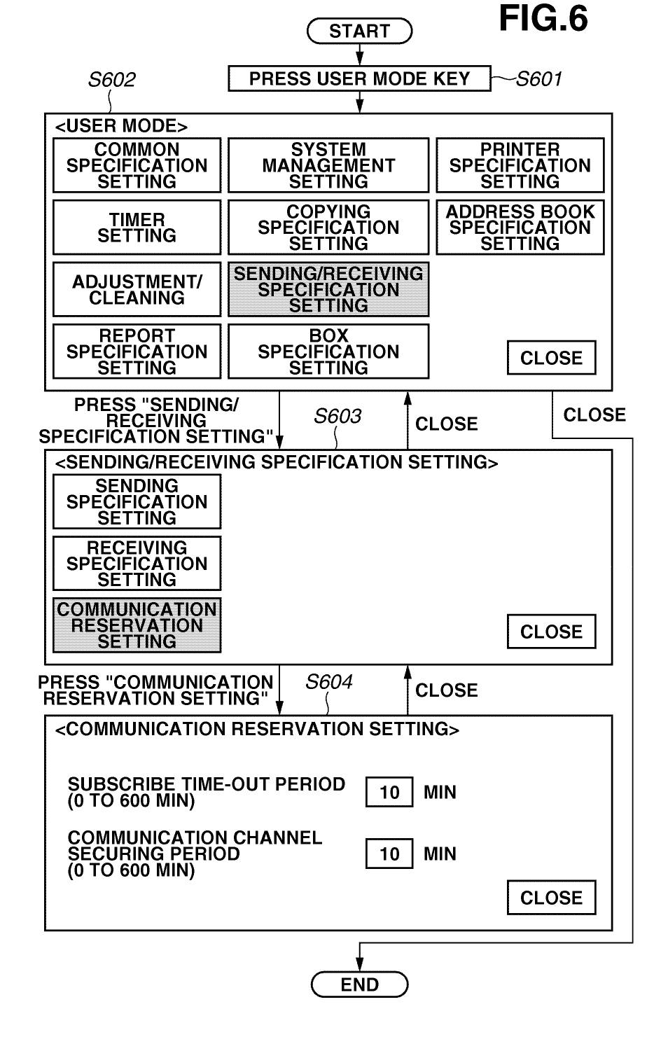

FIG. 6 illustrates a transition of screens for allowing a user to set the above described time-out period and time during which the communication channel is secured (predetermined time). Each screen illustrated in FIG. 6 is displayed on a liquid crystal display unit provided in the operation panel unit 120.

First, in step S601, if the user presses a user mode key provided in the operation panel unit 120, the process proceeds to step S602, and the operation panel unit 120 displays a user mode screen. When a “sending/receiving specification setting” button is pressed on the screen, the process proceeds to step S603, and the operation panel unit 120 displays a sending/receiving specification setting screen. Further, when a “communication reservation setting” button is pressed on the screen, the process proceeds to step S604, and the operation panel unit 120 displays a communication reservation setting screen.

On the communication reservation setting screen, the user can individually set a time-out period to be stored in the expiration field of “SUBSCRIBE” which is sent in step S403 of FIG. 4 and a communication channel securing period used for a determination in step S407. Here, if the user sets, for example, a SUBSCRIBE time-out period at 10 minutes, and the communication channel securing period at 0 minutes, the MFP 210 does not secure the communication channel, even though the MFP 210 requests the receiving apparatus that is in the non-receivable status to notify when the receiving apparatus has shifted to the receivable status. In other words, if the MFP 210 is requested to start data communication with another apparatus before notification from the receiving apparatus that the receiving apparatus has shifted to the receivable status, the MFP 210 executes preferentially data communication with the other apparatus. In the screens illustrated in FIG. 6, the SUBSCRIBE time-out period and the communication channel securing period are designed to be individually set, but they may be collectively set as one setting. That is, either one of the SUBSCRIBE time-out period and the communication channel securing period is set, and the same period may be automatically set to the one that is not set in the screens. In this case, time and effort for setting that the user takes can be saved. In accordance with the first exemplary embodiment, a communication channel for sending image data may be secured when a receiving apparatus is in a non-receivable status, so that the image data can be sent to the receiving apparatus when the receiving apparatus has shifted to a receivable status.

In a second exemplary embodiment of the present invention, similar to the first exemplary embodiment, a case where the MFP 220 is in a non-receivable status when the MFP 210 transmits a call to the MFP 220 for sending image data will be described below. An example where the communication channel is secured at the MFP 210 side is described in the first exemplary embodiment, but in the second exemplary embodiment, an example where the communication channel is secured at the MFP 220 side will be described. More specifically, in the second exemplary embodiment, the MFP 220 secures the communication channel for receiving the image data from the MFP 210 during a period after notifying the MFP 210 that the MFP 220 has shifted to the receivable status until the MFP 210 receives again the call from the MFP 210 for sending the image data.

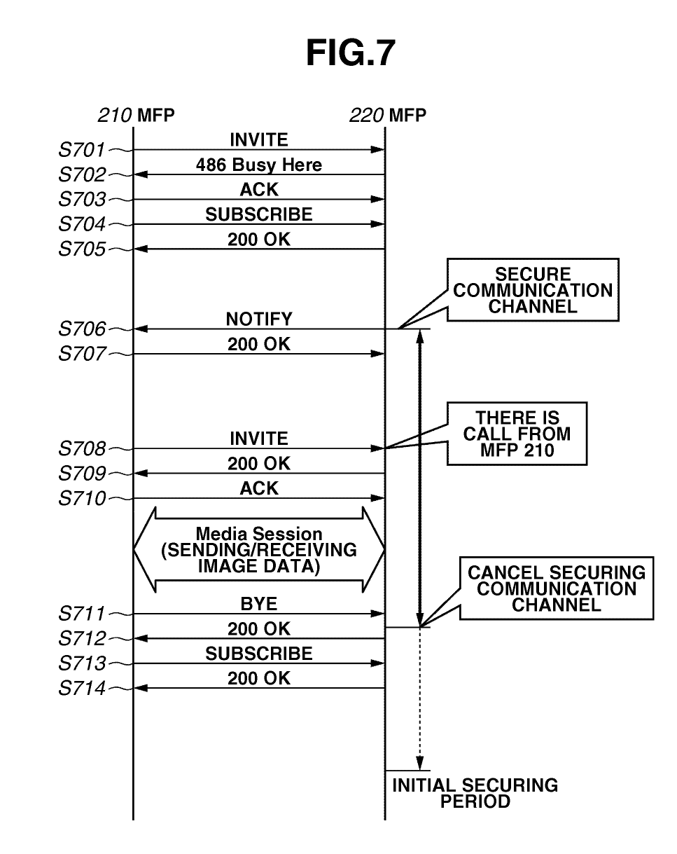

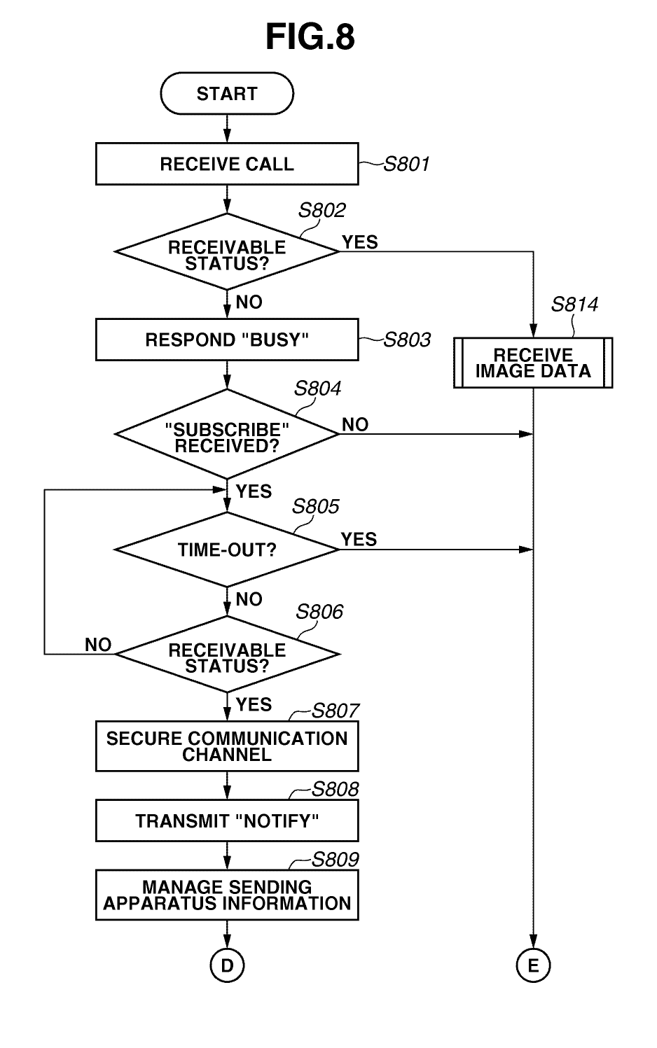

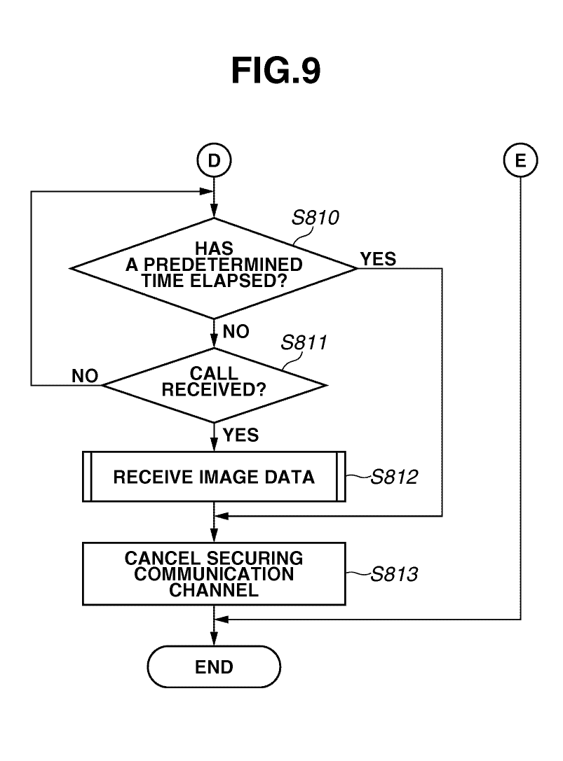

FIG. 7 illustrates a sending sequence of the image data from the MFP 210 to the MFP 220 according to the second exemplary embodiment. FIG. 7 illustrates an example where the MFP 220 which is requested from the MFP 210 to notify when the MFP 220 has shifted to the receivable status secures the communication channel for receiving the image data from the MFP 210 after notifying the MFP 210 that the MFP 220 has shifted to the receivable status. FIGS. 8 and 9 are flowcharts illustrating a series of operations in the MFP 220, when the image data is sent from the MFP 210 to the MFP 220. The CPU 163 of the MFP 220 (the MFP 100) controls the series operations illustrated in these flowcharts based on respective programs stored in a program ROM 175.

First, in step S801, the MFP 220 receives a call from the MFP 210. More specifically, the MFP 220 receives “INVITE” sent from the MFP 210, as illustrated in step S701 of FIG. 7. Next, in step S802, the MFP 220 determines whether it is in the receivable status. If the MFP 220 is in the receivable status (YES in step S802), the MFP 220 sends “200 OK”, and the process proceeds to step S814. Alternatively, if the MFP 220 is determined as in the non-receivable status (NO in step S802), the process proceeds to step S803, then the MFP 220 sends “486 Busy Here” in step S702 in FIG. 7. Further, the MFP 220 receives “ACK” sent from the MFP 210 in step S703. Determination in step S802 is performed based on whether the communication channel provided by the MFP 220 has been already used for data communication with an MFP other than MFP 210. That is, if the communication channel is being used for data communication with the other MFP, it is determined that the MFP 220 is currently in the non-receivable status, because the MFP 220 can not be used for data communication with the MFP 210. On the other hand, when the communication channel (at least one of channels if the MFP 220 has a plurality of communication channels) is not being used, it is determined that the MFP 220 is currently in the receivable status.

In step S804, the MFP 220 determines whether “SUBSCRIBE” is received. If “SUBSCRIBE” is sent from the MFP 210 (YES in step S804), as illustrated in step S704 of FIG. 7, the MFP 220 sends “200 OK” to the MFP 210 in step S705, then the process proceeds to step S805. When the MFP 220 has not received “SUBSCRIBE” (NO in step S804), the process terminates as it is.

In the expiration field of “SUBSCRIBE”, the information about the SUBSCRIBE time-out period set by the user on the communication reservation setting screen displayed in step S604 of FIG. 6 is stored. In step S805, the MFP 220 determines whether the time-out period indicated by the information that is stored in the expiration field has elapsed since the MFP 220 received “SUBSCRIBE”. If the time-out period has not elapsed as a result of determination in step S805 (NO in step S805), the process proceeds to step S806. On the other hand, if the time-out period has elapsed (YES in step S805), the process terminates as it is.

In step S806, the MFP 220 determines whether the MFP 220 is in the receivable status, similar to step S802. If it is determined that the MFP 220 is in the receivable status (YES in step S806), the process proceeds to step S807, and if not (NO in step S806), the process returns to step S805. In step S807, the MFP 220 secures the communication channel to prepare for receiving the image data from the MFP 210. This is because even though the MFP 220 notified the MFP 210 that it has shifted to the receivable status, the MFP 220 cannot receive the image data if the MFP 220 has shifted again to the non-receivable status when the call is again transmitted from the MFP 210.

In order to avoid the above described situation, in the second exemplary embodiment, the MFP 220 receives a notification request from the MFP 210, the MFP 220 secures the communication channel for receiving the image data from the MFP 210 on the basis that the MFP 220 has shifted to the receivable status. That is, the MFP 220 prohibits the use of the communication channel for receiving the image data from the MFP 210 for data communication with apparatuses other than the MFP 210, and becomes ready for immediately receiving the image data from the MFP 210, when the call is transmitted again from the MFP 210.

Here, the present embodiment describes an example where the MFP 220 secures the communication channel on the basis that the MFP 220 has shifted to the receivable status, but other exemplary embodiments are also available. For example, the MFP 220 may secure the communication channel on the basis that the MFP 220 sends “NOTIFY” to the MFP 210 in step S808.

Further, if the MFP 220 is in the non-receivable status when receiving the call from the sending apparatus, the MFP 220 may automatically notify the sending apparatus, which transmits the call, that the MFP 220 has shifted to the receivable status, even when “SUBSCRIBE” is not sent from the sending apparatus. In this case, if “SUBSCRIBE” is not sent from the sending apparatus, the MFP 220 secures the communication channel on the basis that it has shifted to the receivable status.

Further, if the MFP 220 has a plurality of communication channels and can respectively execute data communication with a plurality of MFPs in parallel, the MFP 220 has only to secure at least one communication channel among the plurality of communication channels. In this case, other communication channels except for the secured communication channel are permitted to be used for communication with apparatuses other than the MFP 210.

In step S808, the MFP 220 sends “NOTIFY” to the MFP 210 as illustrated in step S706 in FIG. 7. That is, the MFP 220 notifies the MFP 210 that the MFP 220 has shifted to the receivable status. Then, the MFP 220 receives “200 OK” sent from the MFP 210 in step S707.

In step S809, the MFP 220 stores and manages information for identifying a destination (i.e., the MFP 210) to which the MFP 220 send “NOTIFY” in the external memory 130. Here, any information can be used for identifying the MFP 210 as long as the information can uniquely identify the MFP 210, such as tag information of From Header of the SIP message and Call_ID.

Then in step S810, the MFP 220 determines whether a predetermined time has elapsed since the MFP 220 secured the communication channel necessary for receiving the image data from the MFP 210. The predetermined time is based on the communication channel securing period which is set by the user on the communication reservation setting screen displayed in step S604 of FIG. 6. If the predetermined time has elapsed (YES in step S810) as a result of determination in step S810, the process proceeds to step S813, and if not (NO in step S810), the process proceeds to step S811.

In step S811, the MFP 220 determines whether the MFP 220 has received the call again from the MFP 210. More specifically, if “INVITE” is sent from the MFP 210, as illustrated in step S708 of FIG. 7, the MFP 220 determines to have received the call from the MFP 210.

If the MFP 220 has received the call from the MFP 210 (YES in step S811) as a result of determination in step S811, then the MFP 220 sends “200 OK” to the MFP 210 in step S709 and receives “ACK” sent from the MFP 210 in step S710. On the other hand, if the MFP 220 has not received the call from the MFP 210 (NO in step S811), the process returns to step S810.

When making a determination in step S811, the MFP 220 determines whether an MFP that has sent “INVITE” is the MFP (the MFP 210) that is indicated by the information managed in step S809. As a result of the determination, if the MFP that has sent “NOTIFY” is the MFP (the MFP 210) that is indicated by the information managed in step S809, the MFP 220 determines to have received the call from the MFP 210. On the other hand, if the MFP that has sent “INVITE” is not the MFP (the MFP 210) that is indicated by the information managed in step S809, the MFP 220 determines to have not yet received the call from the MFP 210.

In step S812, the process moves to the media session, and the MFP 220 receives the image data from the MFP 210. Similarly, if the MFP 220 is determined as in the receivable status in step S802 (YES in step S802), the process moves to the media session, and the MFP 220 receives the image data from the MFP 210 in step S814.

In FIG. 7, upon receiving the image data, the MFP 220 receives “BYE” sent from the MFP 210 in step S711, then in step S712, the MFP 220 sends “200 OK” as a response to the MFP 210.

In step S813, the MFP 220 releases the secured communication channel for receiving the image data from the MFP 210. That is, the MFP 220 opens the communication channel secured in step S807, so that the communication channel can be used for data communication with other MFPs except for the MFP 210.

Here, the MFP 220 manages information indicating a sending source (the MFP 210) of the “SUBSCRIBE” on the basis that the MFP 220 has received “SUBSCRIBE” in step S804. Further, the MFP 220 erases the information on the basis that the MFP 220 has sent “NOTIFY” in step S808. However, the MFP 220 may erase the information by the following method instead of erasing the information on the basis that the MFP 220 has sent “NOTIFY”.

That is, the MFP 220 may erase the above described information on the basis that “SUBSCRIBE” in which information indicating that the time-out period in the expiration field is zero is stored is sent in step S713 after the MFP 220 received the image data from the MFP 210. In step S714, the MFP 220 sends “200 OK” to the MFP 210 on the basis that “SUBSCRIBE” is sent in step S713. As described above, the MFP 220 can be ready for reliably receiving the image data when receiving the call again from the MFP 210 after notifying the sending apparatus that the own apparatus has shifted to the receivable status. In accordance with the second exemplary embodiment, a communication channel necessary for receiving image data may be secured when a receiving apparatus has shifted to a receivable status, so that the image data can be received by the receiving apparatus.

A third exemplary embodiment of the present invention describes a case where the MFP 210 transmits a call to the MFP 220 for sending the image data and a response from the MFP 220 to the call indicates that the MFP 220 is in the non-receivable status similar to a first exemplary embodiment. Differences between the third exemplary embodiment and the first exemplary embodiment is that a new step S1001 is added between step S402 and step S403 in the flowchart of FIG. 4 which is described in the first exemplary embodiment.

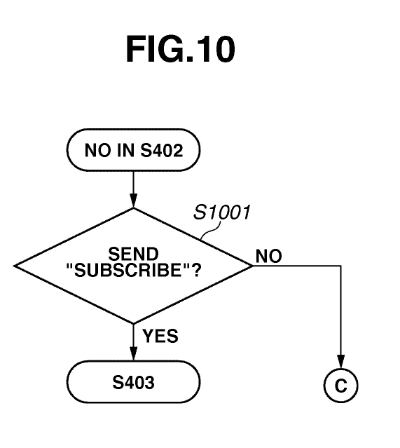

FIG. 10 is a flowchart for illustrating a series of operations in the MFP 210 when the image data is sent from the MFP 210 to the MFP 220, which corresponds to the flowchart illustrated in FIG. 4. According to the third exemplary embodiment, if the MFP 220 is determined as in the non-receivable status in step S402 in FIG. 4 (NO in step S402), the process proceeds to step S1001 in FIG. 10 before proceeding to step S403.

In step S1001, the MFP 210 determines whether to send “SUBSCRIBE” to the MFP 220. More specifically, the MFP 210 determines whether to send “SUBSCRIBE” to the MFP 220 based on information indicating the MFP to which the MFP 210 should send “SUBSCRIBE” that the user sets beforehand using a method as described below. If it is determined that the MFP 210 should send “SUBSCRIBE” (YES in step S1001), the process proceeds to step S403, then in step S304 in FIG. 3, the MFP 210 sends “SUBSCRIBE” to the MFP 220. On the other hand, if it is not determined that the MFP 210 should send “SUBSCRIBE” (NO in step S1001), the process terminates as it is.

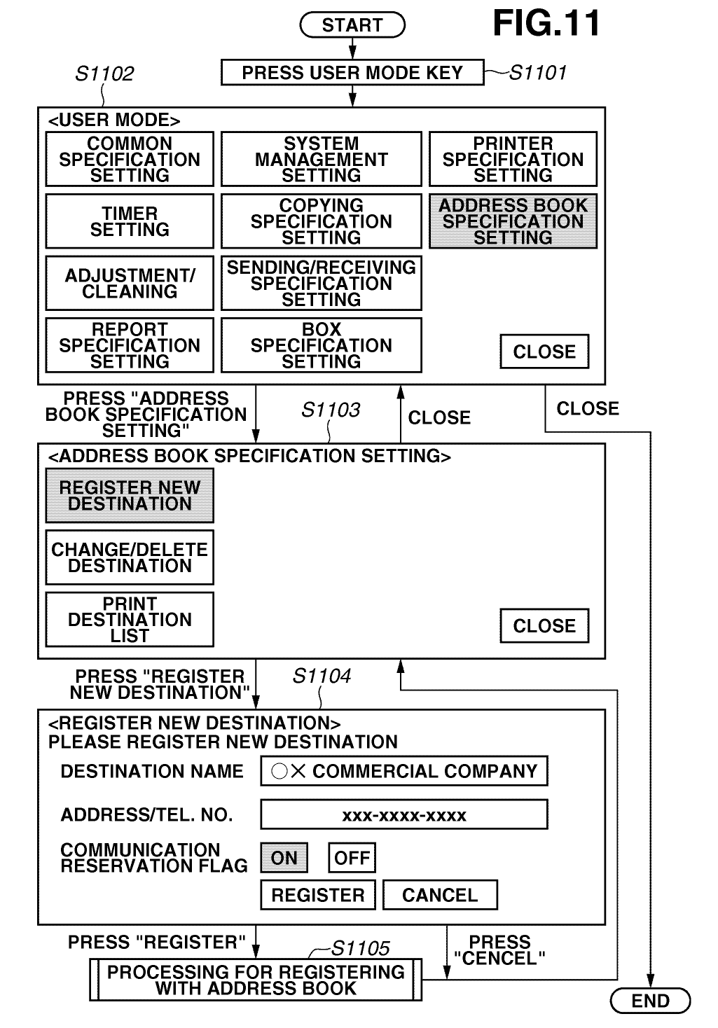

FIG. 11 illustrates a transition of screens for registering a new destination in an address book table which is stored and managed in the external memory unit 130. Each screen illustrated in FIG. 11 is displayed on the liquid crystal display unit provided in the operation panel unit 120.

First, in step S1101, if a user presses the user mode key provided in the operation panel unit 120, the process proceeds to step S1102, and the operation panel unit 120 displays the user mode screen. If an “address book specification setting” button is pressed on the screen, the process proceeds to step S1103, and the operation panel unit 120 displays an address book specification setting screen. Further, if a “register new destination” button is pressed on the screen, the process proceeds to the step S1104, and the operation panel unit 120 displays a new destination registration screen. On the new destination registration screen, the user inputs destination information used for specifying a sending destination of the image data and information used for determination in step S1001 of FIG. 10. That is, the user inputs a name and e-mail address and/or telephone number of the destination of the image data on the new destination registration screen, and selects ON/OFF of a communication reservation flag. When the user presses a “register” button, then in step S1105, the inputted information is registered in the address book.

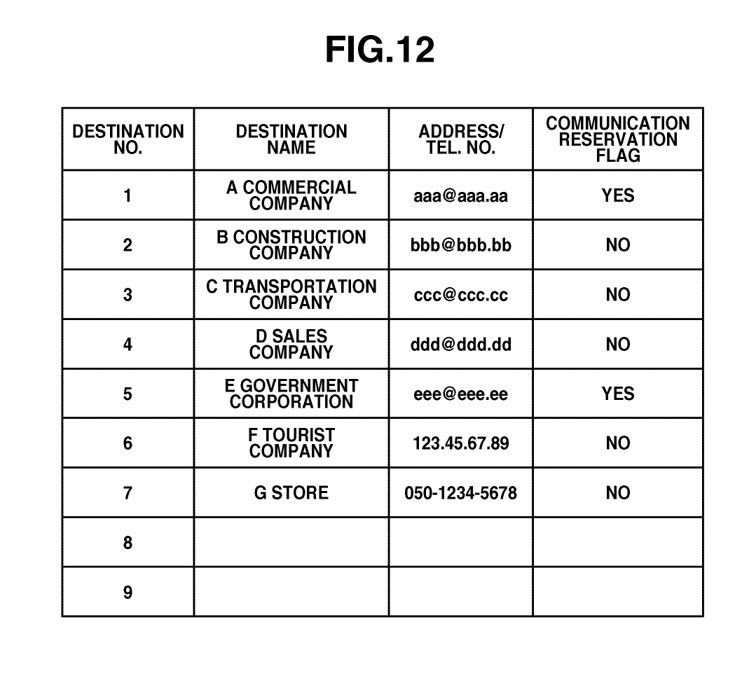

FIG. 12 illustrates an address book table for managing the information input via the new destination registration screen as illustrated in FIG. 11. As illustrated in FIG. 12, information about destination numbers, destination names, addresses/telephone numbers, and information indicating ON/OFF of the communication reservation flag are managed in the address book table. The communication reservation flag is information indicating whether a notification that a destination of call is in the receivable status, is requested when it has shifted to the receivable status if “486 Busy Here” is sent from the destination of call. In other words, if it is determined that the MFP 220 is in the non-receivable status in step S402 in FIG. 4, the MFP 210 refers to the address book table as illustrated in FIG. 12 and determine that the MFP 210 sends “SUBSCRIBE” when the communication reservation flag of the MFP 220 is ON. In this case, when the destination of call is not registered in the address book table, the MFP 210 is set to determine that “SUBSCRIBE” is not to be sent. However, the MFP 210 may be set to determine that “SUBSCRIBE” is to be sent.

As described above, when the receiving apparatus is in the non-receivable status, the sending apparatus can determine whether to request the receiving apparatus to notify the sending apparatus of receivable status based on the information previously specified by the user. Consequently, if the receiving apparatus is in the non-receivable status, the present exemplary embodiment can prevent the sending apparatus from constantly sending “SUBSCRIBE”, and constantly securing the communication channel for sending the image data. In other words, the present exemplary embodiment can prevent a problem that the communication channel is secured to send the image data of low priority which cannot be executed because of the non-receivable status, so that other data communication of high priority cannot be executed.

A fourth exemplary embodiment of the present invention describes a case where the MFP 220 is in a non-receivable status when the MFP 210 transmits a call to the MFP 220 for sending image data similar to the first exemplary embodiment. In the first exemplary embodiment, the MFP 210 secures a communication channel, but in the fourth exemplary embodiment, the MFP 220 secures the communication channel. Differences between the fourth exemplary embodiment and the second exemplary embodiment is that a new step S1301 is added between step S804 and step S805 in the flowchart of FIG. 8 which is described in the second exemplary embodiment.

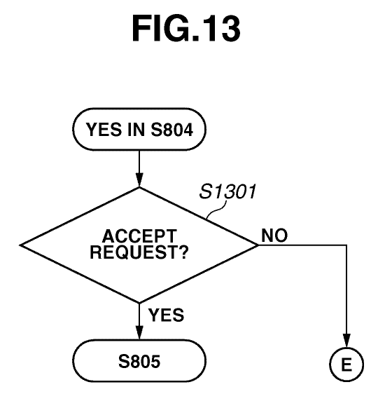

FIG. 13 is a flowchart for illustrating a series of operations in the MFP 220 when sending the image data from the MFP 210 to the MFP 220, which corresponds to the flowchart as illustrated in FIG. 8. According to the fourth exemplary embodiment, in step S804 of FIG. 8, if “SUBSCRIBE” is sent from the MFP 210 (YES in step S804), the process proceeds to step S1301 in FIG. 13 before proceeding to step S805.

In step S1301, the MFP 220 determines whether to accept the request from the MFP 210 to notify the MFP 210 when the MFP 220 has shifted to the receivable status. More specifically, the MFP 220 determines based on the communication reservation flag which is set via the new destination registration screen illustrated in FIG. 11 and managed by the address book table illustrated in FIG. 12. When “SUBSCRIBE” is sent from the MFP 210, the MFP 220 refers to the address book table and accepts the notification request from the MFP 210 if the communication reservation flag of the MFP 210 is ON, then in step S705, the MFP 220 sends “200 OK”. Then, the process proceeds to step S805. On the other hand, if the communication reservation flag of the MFP 210 is OFF, the MFP 220 terminates the process as it is without sending “200 OK”. In this case, when a sending destination of “SUBSCRIBE” is not registered in the address book table, the notification request is not accepted. However, the notification request may be accepted.

As described above, when the receiving apparatus is requested from the sending apparatus to notify of shifting to the receivable status, the receiving apparatus can determine whether to accept the notification request based on the information previously specified by the user. Consequently, if the receiving apparatus is requested to notify the sending apparatus that the receiving apparatus has shifted to the receivable status, the present exemplary embodiment can prevent the receiving apparatus from constantly accepting the request notifying of shifting to the receivable status, and securing the communication channel. In other words, the present exemplary embodiment can prevent a problem that the communication channel is secured to receive the image data of low priority which the sending apparatus intends to receive, so that other data communication of high priority cannot be received.

Configurations in the first through fourth exemplary embodiments as described above may be individually provided, or may be provided in combination with one another. For example, one communication apparatus may be configured with a sending apparatus described in the first or the third exemplary embodiment and a receiving apparatus described in the second or the fourth exemplary embodiment. Further, the SUBSCRIBE time-out period and the communication channel securing period that can be set on the communication reservation setting screen as illustrated in FIG. 6 may be set for each destination on the new destination registration screen as illustrated in FIG. 11. Consequently, a communication reservation method can be individually set for each destination and usability can be improved.

The above described exemplary embodiments of the present invention include, for example, a system, an apparatus, a method, a program and a storage medium (recording medium). More specifically, the exemplary embodiments of the present invention may be applied to a system including a plurality of devices and an apparatus including a single device.

The present invention includes a case where a program of software that achieves functions of the above described exemplary embodiments (a program corresponding to the flowcharts illustrated in drawings in the exemplary embodiments) is directly or remotely supplied to a system or an apparatus, and a computer included in the system or the apparatus reads out and executes the supplied program code to achieve the functions of the exemplary embodiments.

Accordingly, the program code itself which is installed in the computer to achieve the functions and processes of the exemplary embodiments of the present invention by the computer constitutes the above-described embodiments. In other words, the computer program itself for achieving the functions and processes of the exemplary embodiments of the present invention constitutes the present invention. In this case, the program can be in any form, such as object code, a program executed by an interpreter, and script data supplied to an operating system (OS) so long as they have a function of a program.

A recording medium for supplying a program includes a floppy disk, a hard disk, an optical disc, a magneto-optical disk (MO), a compact disc read-only memory (CD-ROM), a compact disc-recordable (CD-R), a compact disc-rewritable (CD-RW), a magnetic tape, a non-volatile memory card, a read-only memory (ROM), a digital versatile disc (DVD) (a DVD-read only memory (DVD-ROM), a DVD-recordable (DVD-R)).

As a method for supplying a program, the program can be downloaded from an Internet website to a recording medium such as a hard disk using a browser of a client computer. That is, the client computer is connected to a website, and the computer program of the exemplary embodiments of the present invention or a compressed file including an automated installation function can be downloaded from the website. Further, the present invention can be implemented by dividing a program code that constitutes the program of the exemplary embodiments of the present invention into a plurality of files, and downloading each file from different websites. In other words, a World Wide Web (WWW) server which allows a plurality of users to download a program file for achieving the functions and processes of the exemplary embodiments of the present invention on a computer also constitutes the present invention.

Furthermore, the program of the exemplary embodiments of the present invention can be encrypted, stored in a computer-readable storage medium, such as a CD-ROM, and distributed to users. In this case, a user who satisfies a predetermined condition can download decryption key information from a website via the Internet. Then, the user can execute the encrypted program by using the key information, and install the program on the computer to implement the present invention.

Further, a computer reads out and executes a program to implement the functions of the above described exemplary embodiments. Alternatively, an operating system (OS) or the like running on the computer can perform a part or whole of the actual processing based on an instruction of the program and implement the functions of the above described exemplary embodiments.

Further, the functions of the above described exemplary embodiments can also be implemented when the program read out from a recording medium is written in a memory provided in a function expansion board inserted into a computer or a function expansion unit connected to the computer, and a CPU of the function expansion board or the function expansion unit execute a part or whole of the actual processing based on the instruction of the program.

While the present invention has been described with reference to the exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-067732 filed Mar. 17, 2008, which is hereby incorporated by reference herein in its entirety.

What is claimed is:

1. A sending apparatus which sends image data comprising:
a call unit configured to transmit a call to a receiving apparatus to send the image data; and
a securing unit configured to secure a communication channel for sending the image data to the receiving apparatus until the receiving apparatus sends a notification that the receiving apparatus has shifted to a receivable status, if a response from the receiving apparatus to the call transmitted by the call unit indicates that the receiving apparatus is in a non-receivable status.

2. The sending apparatus according to claim 1, further comprising a request unit configured to request the receiving apparatus to notify the sending apparatus that the receiving apparatus has shifted to the receivable status, if the response from the receiving apparatus to the call transmitted by the call unit indicates that the receiving apparatus is in the non-receivable status,
wherein the securing unit secures the communication channel until the receiving apparatus sends the notification that the receiving apparatus has shifted to the receivable status in response to the request which is made by the request unit.

3. The sending apparatus according to claim 2, further comprising a first management unit configured to manage information for identifying the receiving apparatus to which the request unit has made the request, in a case where the request unit makes the request to the receiving apparatus; and
a first determination unit configured to determine, when the receiving apparatus sends the notification that the receiving apparatus has shifted to the receivable status, whether the receiving apparatus that sends the notification is the receiving apparatus that is indicated by the information managed by the first management unit,
wherein, if the receiving apparatus that sends the notification is determined as the receiving apparatus that is indicated by the information managed by the first management unit as a result of determination by the first determination unit, the call unit transmits the call again to the receiving apparatus.

4. The sending apparatus according to claim 2, further comprising a cancellation unit configured to cancel the request to the receiving apparatus which is made by the request unit when a predetermined time has elapsed since the securing unit secured the communication channel.

5. The sending apparatus according to claim 1, further comprising a releasing unit configured to release the secured communication channel by the securing unit, when a predetermined time has elapsed since the securing unit secured the communication channel.

6. The sending apparatus according to claim 2, further comprising a second management unit configured to manage information indicating the receiving apparatus to which the request unit makes the request; and
a second determination unit configured to determine, when a response from the receiving apparatus to the call transmitted by the call unit indicates that the receiving apparatus is in the non-receivable status, whether the receiving apparatus that sends the response is the receiving apparatus that is indicated by the information managed by the second management unit,
wherein as a result of determination by the second determination unit, if the receiving apparatus that sends the response is determined as the receiving apparatus that is indicated by the information managed by the second management unit, the request unit makes the request to the receiving apparatus.

7. The sending apparatus according to claim 1, wherein the sending apparatus can execute a plurality of data communications in parallel using a plurality of communication channels, and the securing unit secures at least one communication channel which is not used for data communication with apparatuses other than the receiving apparatus among the plurality of communication channels.

8. A receiving apparatus which receives image data comprising:
a first notification unit configured to notify a sending apparatus, when the receiving apparatus receives a call from the sending apparatus for sending the image data and is in a non-receivable status, that the receiving apparatus is in the non-receivable status;
a second notification unit configured to notify the sending apparatus that the receiving apparatus has shifted to a receivable status when the receiving apparatus has shifted to the receivable status after the first notification unit sent a notification; and
a securing unit configured to secure, when the receiving apparatus has shifted to the receivable status, a communication channel for receiving the image data from the sending apparatus until the receiving apparatus again receives the call for sending the image data from the sending apparatus that received a notification from the second notification unit.

9. The receiving apparatus according to claim 8, further comprising a first management unit configured to manage information for identifying the sending apparatus to which the second notification unit sends the notification, in a case where the second notification unit sends the notification;
a first determination unit configured to determine whether the sending apparatus that transmits the call is the sending apparatus that is indicated by the information managed by the first management unit, when the receiving apparatus receives the call for sending the image data from the sending apparatus after the second notification unit sends the notification; and
a control unit configured to perform control to receive the image data from the sending apparatus, when the sending apparatus that transmits the call is determined as the sending apparatus that is indicated by the information managed by the first management unit, as a result of determination by the first determination unit.

10. The receiving apparatus according to claim 8, further comprising a releasing unit configured to release the secured communication channel by the securing unit, when a predetermined time has elapsed since the securing unit secured the communication channel.

11. The receiving apparatus according to claim 8, further comprising a second management unit configured to manage information indicating the sending apparatus to which the second notification unit sends the notification; and
a second determination unit configured to determine whether the sending apparatus that made the request is the sending apparatus that is indicated by the information managed by the second management unit, when the receiving apparatus is requested from the sending apparatus to notify the sending apparatus that the receiving apparatus has shifted to the receivable status,
wherein if the sending apparatus that made the request is determined as the sending apparatus that is indicated by the information managed by the second management unit, as a result of determination by the second determination unit, the second notification unit sends the notification to the sending apparatus.

12. The receiving apparatus according to claim 8, wherein the receiving apparatus can execute a plurality of data communications in parallel using a plurality of communication channels, and the securing unit secures at least one communication channel which is not used for data communication with apparatuses other than the receiving apparatus among the plurality of communication channels.

13. A method for controlling a sending apparatus which sends image data, the method comprising:
transmitting a call to a receiving apparatus to send the image data; and
securing a communication channel for sending the image data to the receiving apparatus until the receiving apparatus sends a notification that the receiving apparatus has shifted to a receivable status, if a response from the receiving apparatus to the call indicates that the receiving apparatus is in a non-receivable status.

14. A method for controlling a receiving apparatus which receives image data, the method comprising:
notifying a sending apparatus, when the receiving apparatus is in a non-receivable status upon receiving a call to send the image data from the sending apparatus, that the receiving apparatus is in the non-receivable status;
notifying the sending apparatus that the receiving apparatus has shifted to a receivable status when the receiving apparatus has shifted to the receivable status after notifying that the receiving apparatus is in the non-receivable status; and
securing a communication channel for receiving the image data from the sending apparatus when the receiving apparatus has shifted to the receivable status, until the receiving apparatus again receives the call to send the image data from the sending apparatus that has received a notification that the receiving apparatus has shifted to the receivable status.

15. A computer-readable storage medium that stores a program for causing a computer to execute a method comprising:
transmitting a call to a receiving apparatus to send image data; and
securing a communication channel for sending the image data to a receiving apparatus until the receiving apparatus sends a notification that the receiving apparatus has shifted to a receivable status, if a response from the receiving apparatus to the call indicates that the receiving apparatus is in a non-receivable status.

16. A computer-readable storage medium that stores a program for causing a computer to execute a method comprising:
notifying a sending apparatus, when a receiving apparatus is in a non-receivable status upon receiving a call to send image data from the sending apparatus, that the receiving apparatus is in the non-receivable status;
notifying the sending apparatus that the receiving apparatus has shifted to a receivable status when the receiving apparatus has shifted to the receivable status after notifying that the receiving apparatus is in the non-receivable status; and
securing a communication channel for receiving the image data from the sending apparatus when the receiving apparatus has shifted to the receivable status, until the receiving apparatus again receives the call to send the image data from the sending apparatus that has received a notification that the receiving apparatus has shifted to the receivable status.
